(19) United States
(12) Patent Application Publication
(10) Pub. No.: US 2015/0306672 A1
(43) Pub. Date: Oct. 29, 2015

(54) Cutting tool assembly

(71) Applicant: Rigibore Limited, Cornwall (GB)

(72) Inventors: Roger Bassett, Cornwall (GB); Adam Trevarthen, Cornwall (GB)

(73) Assignee: Rigibore Limited, Cornwall (GB)

(21) Appl. No.: 14/685,985

(22) Filed: Apr. 14, 2015

(30) Foreign Application Priority Data
Apr. 29, 2014 (GB) 1407527.9

(51) Int. Cl. B23B 27/16

(52) U.S. Cl. CPC B23B 27/1681; B23B 2260/004

(57) ABSTRACT

A cutting tool assembly is provided, the assembly comprising a support body; a holder having a portion for holding a cutting insert, wherein the holder is mounted to the support body for movement of the cutting insert with respect to the support body; an adjustment assembly for moving the position of the holder relative to the support body, the adjustment assembly comprising: an adjustment screw rotatably mounted to the support body; and an adjustment member having an adjustment surface bearing against a surface of the holder, the adjustment member being threadably mounted on the adjustment screw by a first thread on the shank of the adjustment screw; whereby rotation of the adjustment screw moves the adjustment member longitudinally along the adjustment screw, movement of the adjustment member moving the position of the portion of the holder for holding a cutting insert relative to the support body.

The present invention relates to a cutting tool assembly, in particular to an assembly for holding a cutting insert having a cutting edge.

Tools for cutting metal having a cutting edge are well known and have been used for many years in a wide range of metal forming and machining operations. In one known cutting tool assembly, the cutting edge used to cut and form the metal is provided in a cutting insert. The cutting insert in turn is retained in a holder. As the cutting insert wears, the holder may be adjusted to maintain the correct cutting size. When the cutting insert is worn beyond an acceptable limit, it may simply be removed from the holder and replaced with a new cutting insert. Such cutting tool assemblies find extensive use in a wide range of metal working assemblies and in such operations as metal forming and boring.

U.S. Pat. No. 4,786,217 discloses a metal-cutting tool. The tool comprises a holder having a cutting plate or cutting insert mounted on its front part. The holder is integrally formed together with a base body and is connected to the base body at its rearmost end. A perforation provided in the holder forms a spring arrangement, allowing the holder to be resiliently deflected relative to the base. In use, the deflection of the holder relative to the base is adjusted by an adjustment device. The adjustment device comprises an adjustment screw, the head of which bears on a wedge located between the holder and the base. The adjustment screw rotates freely within the wedge. Rotation of the adjustment screw moves the wedge, in particular by way of the head of the adjustment screw bearing upon the wedge, in turn adjusting the deflection of the holder relative to the base. This in turn allows the position of the cutting edge of the cutting insert to be adjusted. The adjustment screw is threaded into a tapped bore in the base body. As a result, while rotation of the screw adjusts the position of the wedge, the position of the screw within the assembly changes.

More recently, EP 1 299 207 discloses a metal cutting tool assembly, in particular a rotational tool for such operations as boring. The assembly comprises a holder into which a cutting insert can be mounted. The holder is mounted to a carrier by way of a pin extending through a hole in the holder. The holder is elastically deflectable relative to a support by means of an adjustment device. The holder is disposed in a recess formed in the carrier, the recess surrounding the holder on three sides. The holder is held within the recess to have a shoulder bear against a surface of the recess. The adjustment device is an adjusting screw having a thread-free tapered portion. The tapered portion bears against a surface on the holder, such that rotation of the adjustment screw causes the tapered portion to move relative to the holder and adjust the position of the cutting insert through elastic deflection of the holder.

There is a need for an improved cutting tool assembly, in particular an assembly for holding a cutting insert. In particular, there is a need for an arrangement that allows for easier and more accurate positioning of the cutting edge of the cutting insert. In addition, it would be most advantageous if the assembly could avoid any form of clamping on the holder in which the cutting insert is mounted, as the action of clamping the holder to lock the assembly tends to move the cutting edge out of alignment.

According to the present invention there is provided a cutting tool assembly comprising:

a support body;

a holder having a portion for holding a cutting insert, wherein the holder is mounted to the support body for movement of the cutting insert with respect to the support body;

an adjustment assembly for moving the position of the holder relative to the support body, the adjustment assembly comprising:

an adjustment screw rotatably mounted to the support body; and

an adjustment member having an adjustment surface bearing against a surface of the holder, the adjustment member being threadably mounted on the adjustment screw by a first thread on the shank of the adjustment screw;

whereby rotation of the adjustment screw moves the adjustment member longitudinally along the adjustment screw, movement of the adjustment member moving the position of the portion of the holder for holding a cutting insert relative to the support body.

The cutting tool assembly of the present invention allows for very accurate adjustment of the position of the cutting edge of the cutting insert. The position of the cutting edge may be adjusted by means of the adjustment screw in a simple manner by the user. In particular, it is not required to remove the assembly from a machine in which it is mounted, such as a milling machine or a boring machine. Rather, the cutting edge can be adjusted with the assembly in situ. Further, as the assembly does not require the holder to be clamped in the support body, the cutting insert cannot be moved as a result of tightening the clamping force on the holder, as is the case with many known assemblies.

In the assembly of the present invention, the adjustment screw does not move axially, but simply rotates. This results in the fabrication of the assembly being simpler, for example avoiding the need for a clearance hole to be formed to accommodate the adjustment screw, as is the case with prior art devices. In addition, the threaded portion of the adjustment screw may be arranged to remain entirely within the support body, in turn protecting the thread from damage.

By having the adjustment member threadably engaged with the adjustment screw, the movement of the adjustment member in either direction is controlled by rotation of the adjustment screw. In this way, the assembly is not reliant on a restoring force being applied to move the adjustment member in one direction, as is the case in the prior art devices.

The assembly of the present invention comprises a holder. The holder is for supporting a cutting insert. Cutting inserts for use in the assembly are known in the art and are commercially available. A range of different cutting inserts are available, depending upon the metal working duty to be performed. One particular form of cutting insert is generally triangular, with a cutting edge formed on at least one side of the insert. Other forms of cutting insert include square, rectangular, and other polygonal shapes. The holder of the assembly can be formed to accommodate such cutting inserts and the form and shape of the cutting insert that can be held in the assembly of the present invention is not limited to one particular form.

The cutting insert may be held in the holder by any suitable means. In one embodiment, the holder is provided with a recess having a shape corresponding to that of the insert to be held. The cutting insert may be mounted to the holder by any suitable means. A screw is one suitable means for mounting the cutting insert to the holder.

The assembly of the present invention further comprises a support body. The holder is mounted to the support body such that it allows movement of a cutting insert mounted in the holder with respect to the support body. The assembly is mounted to a machine, such as a lathe, line boring machine and the like, by way of the support body. The support body may be provided with suitable means to allow it be mounted to an appropriate component of the machine, such as an aperture for receiving a stud, screw or bolt, and/or a mounting screw or bolt.

The holder is mounted to the support body, such that the portion of the holder for holding the cutting insert, and hence the cutting insert, is moveable with respect to the support body. In this way, with the support body rigidly mounted to a component of a machine, the position of the cutting edge of the cutting insert may be changed by adjusting the relative position of the portion of the holder for holding the cutting insert relative to the support body.

In a preferred arrangement, at least the portion of the holder in which a cutting insert is mounted is moveable with respect to the support body against a biasing force. In particular, at least the said portion of the holder is moveable from a first position to a second position against a biasing force, with the biasing force acting to urge the said portion of the holder from the second position to the first position. Ways in which the biasing force may be provided to urge the holder in the aforementioned manner are described in more detail below.

The holder may be integrally formed with the support body, such that the support body can flex to allow the portion of the holder for holding the cutting insert to move relative to the support body. In this embodiment, to provide a biasing force to urge the holder as described above, the holder is most preferably formed to be resilient, the portion of the holder in which the cutting insert is mounted being moveable against the resilient bias of the holder.

More preferably, the holder is a separate component to the support body and is moveably mounted to the support body. In this embodiment, to provide a biasing force on the holder, a resilient biasing member may be provided between the holder and the support body. For example a resilient member, such as a spring, may be provided between the holder and the support body, for example, the resilient member bearing upon a surface of one of the holder and the support body and being mounted to the other of the holder and the support body. In a preferred arrangement, the resilient member is mounted to the support body, for example by a mounting screw, and bears against an opposing surface of the support body. A helical spring is one suitable resilient member for use in the assembly.

It is particularly advantageous to provide a resilient biasing member to apply a biasing force of known magnitude on the holder. In this way, the holder may be formed as a rigid body. This arrangement allows for significantly greater accuracy and rigidity when adjusting and maintaining the position of the cutting edge throughout the adjustment range. In prior art devices, in which the holder is arranged to deform to provide a resilient biasing force, the magnitude of the biasing force is reliant upon the design of the holder and its accurate manufacture. Any irregularities in the design or manufacture of the holder can result in the biasing force varying throughout the adjustment range, in turn affecting the accuracy of the position and rigidity of the cutting edge. These problems are avoided by the embodiments of the present invention which use a resilient biasing member, as described above.

The holder may be mounted to move relative to the support body in any suitable way. In a preferred arrangement, the holder is pivotably mounted with respect to the support body. More preferably, the holder is mounted so as to move about a pivot member extending from the support body. For example, the pivot member may extend through a lateral bore in the holder. In this way, the pivot member also acts to mount the holder to the support body. The pivot member may be any suitable member about which the holder can rotate. In one embodiment, the holder rotates about a screw secured to the support body.

The holder may engage with the support body in any suitable manner. In a preferred embodiment, the support body comprises a first support portion and a second portion spaced apart from the first support portion. The holder is located between the first and second support portions of the support body and is free to move therebetween. In a preferred arrangement, a pivot member, in particular a pivot screw, extends from the first support portion to the second portion. The holder pivots about the pivot screw, more particularly with the pivot screw extending through a lateral bore in the holder.

The assembly further comprises an adjustment screw mounted to the support body. The adjustment screw is rotatable with respect to the support body. Axial movement of the adjustment screw relative to the support body is prevented. In one preferred embodiment, the adjustment screw is rotatable in a bearing of the support body. More preferably, the adjustment screw has a head and a distal end portion, with the bearing arranged at the distal end portion of the adjustment screw. The bearing is preferably a plain bearing arranged to rotate with the adjustment screw, a bearing surface of the bearing contacting a surface of the support body, more preferably a surface within a recess in the support body. In one preferred arrangement, the distal end portion of the adjustment screw is threadably engaged with the bearing, with the adjustment screw being prevented from disengaging from the bearing by a suitable locking means. The locking means is conveniently a thread locking adhesive, for example. Alternatively, the distal end of the adjustment screw may be provided with a blind bore or countersink, allowing the distal end portion of the adjustment screw to be swaged with a press or the like, to thereby lock the distal end of the adjustment screw to the bearing.

Other means to retain the adjustment screw and prevent it from moving axially may be employed. For example, a portion of the adjustment screw may be provided with a circumferential groove. A locking screw is provided in the support body to engage with the circumferential groove in the adjustment screw. In one preferred embodiment, the circumferential groove extends around the head portion of the adjustment screw.

The assembly of the present invention further comprises an adjustment member. The adjustment member has an adjustment surface bearing against a surface of the holder. In this way, movement of the adjustment member causes the holder to move. The adjustment member is threadably mounted on the adjustment screw by a first thread on the shank of the adjustment screw. In this way, rotation of the adjustment screw moves the adjustment member longitudinally along the shank of the adjustment screw, movement of the adjustment member moving the position of the portion of the holder for holding the cutting insert relative to the support body.

As noted, an adjustment surface of the adjustment member bears against a surface of the holder, whereby movement of the adjustment member displaces at least a portion of the holder, causing the cutting edge of the cutting insert to move relative to the support body. Rotation of the adjustment screw causes the adjustment member to move along the shank of the adjustment screw, that is along the longitudinal axis of the adjustment screw. To achieve the aforementioned relative movement, one or both of the adjustment surface of the adjustment member and the opposing surface of the holder contacted by the adjustment surface of the adjustment member are at an angle to the longitudinal axis of the adjustment screw and the line of movement of the adjustment member. It is preferred that the adjustment surface of the adjustment member is at an angle, that is not parallel, to the longitudinal axis of the adjustment screw.

The smaller the angle between the adjustment surface of the adjustment member and/or the opposing surface of the holder and the longitudinal axis of the adjustment screw, the easier it is to perform fine adjustments of the position of the cutting edge. The angle is preferably less than 20°, more preferably less than 15°, still more preferably less than 12°. The angle is preferably greater than 1°, more preferably greater than 2°, still more preferably greater than 3°. The angle is preferably from 1 to 20°, more preferably from 2 to 15°, still more preferably from 3 to 12°. An angle in the range of from 4 to 10° is particularly preferred for many embodiments to provide the required degree of fine adjustment.

The adjustment surface of the adjustment member contacts a surface of the holder. The surface of the holder contacted by the adjustment surface preferably extends at an angle, that is not parallel, to the longitudinal axis of the adjustment screw, more preferably the same angle as that of the adjustment surface of the adjustment member. In this way, the holder is caused to move orthogonally to the longitudinal axis of the adjustment screw throughout the range of movement of the adjustment member.

In one preferred embodiment, the adjustment member is received within a recess formed within the holder, the adjustment surface of the adjustment member contacting an inner surface of the recess of the holder.

As noted above, the adjustment member is threadably engaged with the adjustment screw by a first thread. In embodiments in which the adjustment screw is provided with a bearing for rotation relative to the support body and the bearing is secured to the adjustment screw by a thread, this thread is a second thread and is most preferably an opposite thread to the first thread. In use, the adjustment screw is typically rotated in one direction so as to move the cutting edge of the cutting insert to accommodate wear in the cutting edge. As a result, adjustment of the adjustment screw during use is predominantly by rotation in one direction. By having the second thread opposite to the first thread, normal movement of the adjustment screw to accommodate wear in the cutting edge of the insert will tend to tighten the engagement between the adjustment screw and the bearing, rather than loosen the engagement.

In a further aspect, the present invention provides a machine, such as a lathe, a milling machine or a boring machine, comprising an assembly as hereinbefore described.

In a still further aspect, the present invention provides a kit for working metal comprising a cutting tool assembly as hereinbefore described and at least one cutting insert.

The cutting insert is preferably mounted in the holder of the cutting tool assembly, as hereinbefore described.

Embodiments of the assembly of the present invention will now be described, by way of example only, having reference to the accompanying drawings, in which:

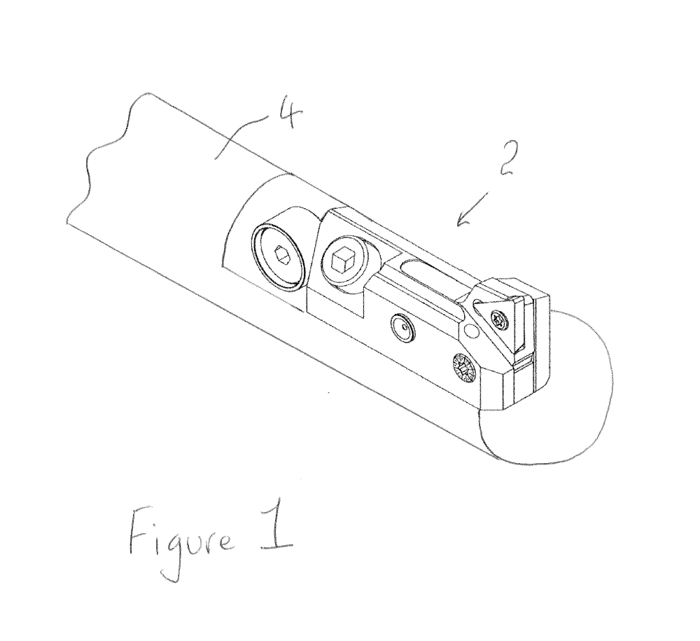

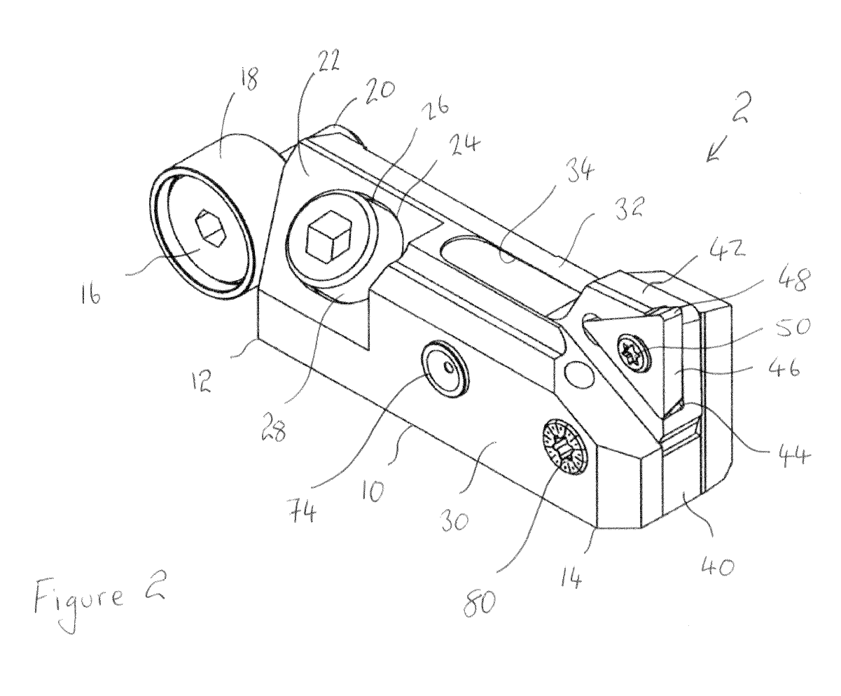

FIG. 1 is a perspective view of one embodiment of a cutting tool assembly of the present invention mounted on a boring bar;

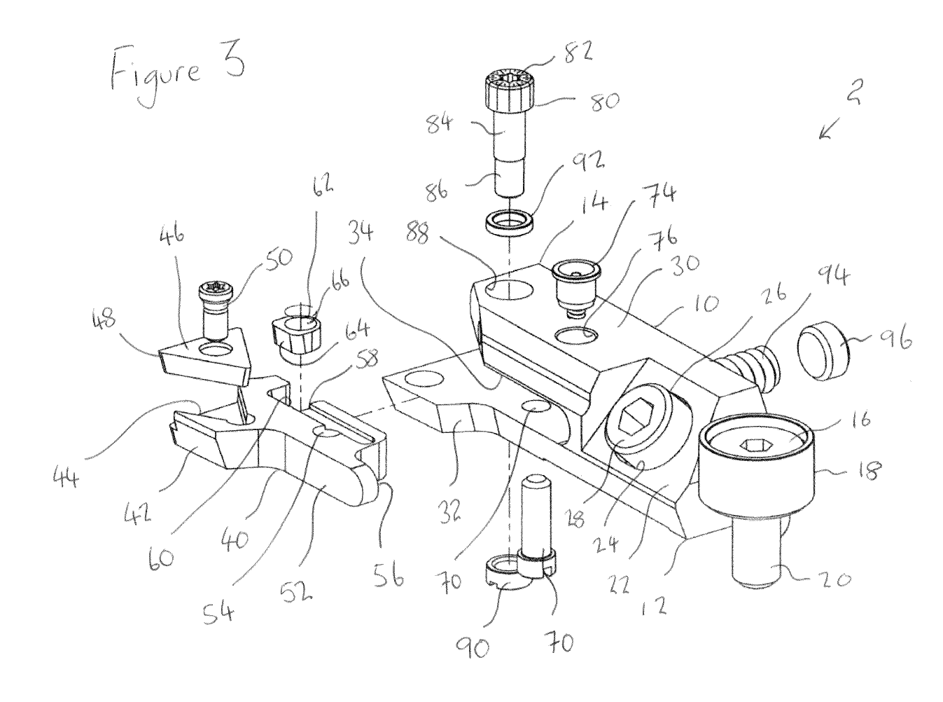

FIG. 2 is a perspective view of the cutting tool assembly of FIG. 1;

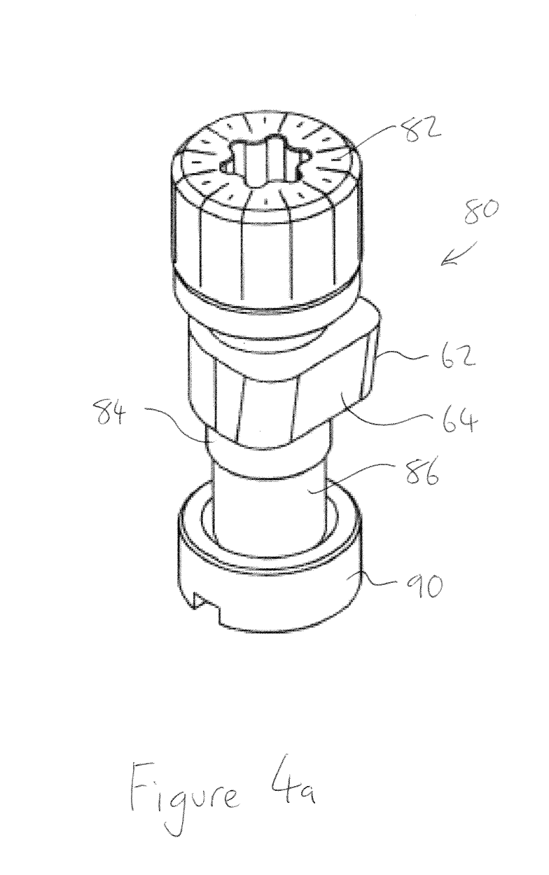

FIG. 3 is an exploded view of the assembly of FIG. 2;

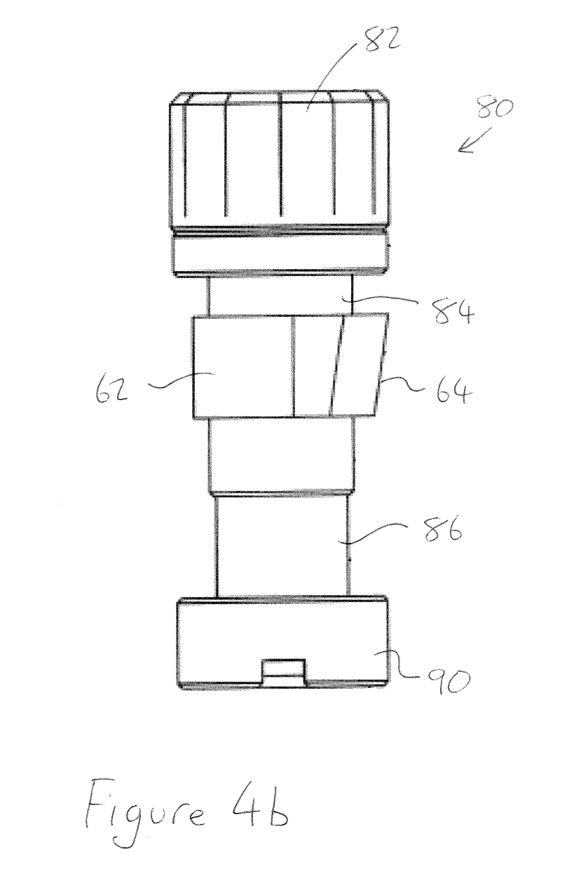

FIG. 4a is a perspective view of the adjustment screw and adjustment member of the assembly of FIG. 2;

FIG. 4b is a side view of the adjustment screw and adjustment member of FIG. 4a; and

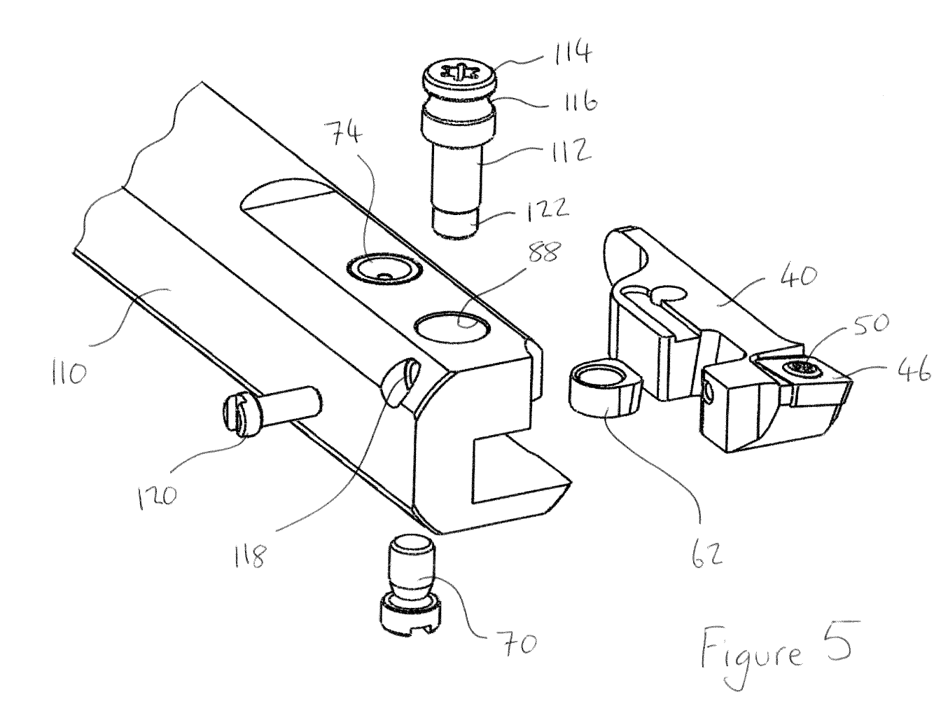

FIG. 5 is an exploded view of a further embodiment of the assembly of the present invention.

Referring to FIG. 1, there is shown a cutting tool assembly of one embodiment of the present invention, generally indicated as 2, mounted on a boring bar 4. The boring bar 4 is of known configuration, for example as commercially available from Rigibore Ltd. The boring bar 4 is installed in a boring machine in a known manner.

The cutting tool assembly 2 is shown in enlarged perspective view in FIG. 2. Referring to FIG. 2, the cutting tool assembly 2 comprises a support body 10 having a first end portion 12 and a second end portion 14. The support body 10 may be referred to as a cartridge and is mounted in the boring bar 4 by way of a mounting screw, having a head 16 and a threaded shank 20, and disposed at the first end of the support body 10. The mounting screw head 16 engages with a cam 18 that allows the axial position of the support body 10 on the boring bar 4 to be adjusted and set.

The first end portion 12 of the support body 10 is formed with a chamfered surface 22 having a bore 24 formed therein. The bore 24 accepts a second mounting screw 26 having a head 28 located in a recessed portion of the bore 24.

The second end portion 14 of the support body 10 is comprised of a first support body portion 30 and a second support body portion 32, the support body portions 30, 32 extending from the first end portion 12 parallel to each other. The first and second support body portions 30, 32 are spaced apart to form a receptacle 34 for a cutting insert holder 40.

The holder 40 is shown more fully in the exploded view of FIG. 3 and comprises an enlarged insert holding portion 42 having a triangular recess 44 formed in one face thereof and extending from an end of the holding portion 42. A triangular cutting insert 46 having a cutting edge 48 is mounted within the recess 44 by a screw 50.

The holder 40 further comprises a mounting portion 52 having a bore 54 extending laterally therethrough. The mounting portion 52 is provided with a bearing surface 56 on the opposite end of the holder 40 to the enlarged insert holding portion 42, such that the bore 54 is between the bearing surface and the enlarged insert holding portion.

A slot 58 is provided in the holder 40, formed in the opposing edge to the enlarged insert holding portion 42. The slot 58 has an angled face 60. The slot 58 receives a generally wedge shaped adjustment member 62 having an angled face 64 for bearing against the angled face 60 of the slot 58. The angled face 64 extends at an angle of from 4 to 10° to the longitudinal axis of an adjustment screw described hereinafter. The adjustment member 62 is provided with a threaded bore 66 therethrough, by which the adjustment member is mounted, as described in more detail below.

A pivot screw 70 extends through a bore 72 in the first support body portion 30, the bore 54 in the holder 40, and is threaded into a corresponding threaded, blind bore in the second support body portion 32. The holder 40 is free to rotate or pivot about the pivot screw 70 in the receptacle 34 between the first and second support body portions 30, 32.

To allow the holder 40 to be lubricated, a grease nipple 74 is provided in a threaded bore 76 in the first support body portion, by which a lubricant may be injected into the receptacle 34 between the first and second support body portions 30, 32 to ensure a smooth motion of the holder 40 about the pivot screw 70.

An adjustment screw 80 having a head 82, a first shank portion 84 adjacent the head 82 having a first thread formed thereon, and a second shank portion 86 having a second thread formed thereon extends through a bore 88 extending through the first and second support body portions 30, 32. The bore 88 has an enlarged portion in the first support body portion 30 for receiving the head 82 of the adjustment screw. The bore 88 has an enlarged portion in the second support body portion 32 for receiving a bearing ring 90. The bearing ring 90 is threaded onto the second shank portion 86 of the adjustment screw 80 and is fixed thereto, for example by way of a thread locking resin. Alternatively or in addition, the end portion of the adjustment screw 80 can be swaged using a press to secure the bearing ring 90 onto the second shank portion 86 of the adjustment screw 80.

In use, the bearing ring 90 rotates with the adjustment screw within the bore 88 in the second support body portion 32. The adjustment member 62 is threaded onto the first shank portion 84 of the adjustment screw 80.

The arrangement of the adjustment screw 80, the bearing ring 90 and the adjustment member 62 is shown in FIGS. 4a and 4b. The adjustment screw 80 is free to rotate within the bore 88, together with the bearing ring 90. Rotation of the adjustment screw 80 causes the adjustment member to move along the first shank portion 84, adjusting the position of the angled surface 64 on the adjustment member relative to the angled surface 60 in the slot 58 of the holder 40. This in turn moves the cutting edge 48 of the cutting insert 46.

To prevent any tendency of the bearing ring 90 from disengaging from the adjustment screw 80, the thread on the first shank portion 84 is opposite in orientation to the thread on the second shank portion 86. In one embodiment, the thread on the first shank portion 84 engaging with the adjustment member is a left hand thread, while the thread on the second shank portion 86 holding the bearing ring 90 is a right hand thread. As movement of the cutting edge 48 of the cutting insert 46 will generally be required to be in one direction, to accommodate wear in the cutting edge 48 through use, the adjustment screw 80 will generally require rotation in only one direction, once the assembly has been set up.

A bearing washer 92 is provided in the bore 88 between the head 82 of the adjustment screw 80 and the first support body portion 30.

To provide a biasing force on the holder 10, a bore is formed in the holder to accept a helical spring 94 retained by a cap 96. The end of the spring 94 contacts the bearing surface 56 of the mounting portion 52 of the holder 40. The spring 94 is held in compression between the cap 96 and the holder 40. Adjustment of the holder 40 by movement of the adjustment member 62 as a result of rotation of the adjustment screw 80 is generally against the biasing force of the spring 94.

In use, to adjust the position of the cutting edge 48 of the cutting insert 46 to accommodate wear in the cutting edge, the adjustment screw 80 is rotated in an anti-clockwise direction. Due to the left hand thread on the first shank portion 84 of the adjustment screw 80, the adjustment member 62 is caused to move along the first shank portion 84 away from the head 82 of the adjustment screw 80 (that is downwards as viewed in FIG. 4a and FIG. 4b). By virtue of the angle of the face 64 on the adjustment member 62 and the angled face 60 of the slot 58 of the holder 40, the holder 40 is caused to pivot about the pivot screw 70, compressing the spring 94 and moving the cutting edge 48 upwards, as viewed in FIG. 2.

As described above, the adjustment screw 80 is retained in the holder 10 so as to be free to rotate but to be axially restrained to prevent axial movement of the screw. In this way, rotation of the adjustment screw 80 is translated into movement of the adjustment member 62 along the screw. An alternative arrangement for retaining the adjustment screw 80 is shown in FIG. 5.

The assembly of FIG. 5 has the same general configuration as the assembly of FIGS. 2 to 4. Components shown in FIG. 5 and common to the embodiment of the assembly shown in FIGS. 2 to 4 are indicated using the same reference numerals as used in the above description. A number of components of the assembly of FIG. 5 have been omitted for clarity.

The assembly of FIG. 5 comprises an elongate support body 110 for receiving a holder 40 having a cutting insert 46. An adjustment screw 112 having a head 114 extends through a bore 88 in the support body 110. An adjustment member 62 is retained by the adjustment screw 112, as described above.

In the assembly of FIG. 5, the adjustment screw 112 is provided with a circumferential groove 116 extending around the head 114 of the screw. A threaded bore 118 is provided in the support body 110 extending perpendicular to the bore 88 receiving the adjustment screw 112. In use, the adjustment screw 112 is installed in the bore 88 in the support body 110, after which a locking screw 120 is threaded into the bore 118 to engage with the circumferential groove 116 in the head 114 of the adjustment screw, whereby axial movement of the adjustment screw 112 is prevented.

The distal end portion 122 of the adjustment screw is plain and is located in a plain blind bore formed in the support body 110 (not shown in FIG. 5). In this way, the adjustment screw 112 is located for rotational movement and is prevented from moving axially. This in turn causes rotation of the adjustment screw 112 to be translated into movement of the adjustment member relative to the holder 40, in turn moving the holder and the cutting edge of the insert 46, as described above.

1. A cutting tool assembly comprising:
a support body;
a holder having a portion for holding a cutting insert, wherein the holder is mounted to the support body for movement of the cutting insert with respect to the support body;
an adjustment assembly for moving the position of the holder relative to the support body, the adjustment assembly comprising:
an adjustment screw rotatably mounted to the support body; and
an adjustment member having an adjustment surface bearing against a surface of the holder, the adjustment member being threadably mounted on the adjustment screw by a first thread on the shank of the adjustment screw;
whereby rotation of the adjustment screw moves the adjustment member longitudinally along the adjustment screw, movement of the adjustment member moving the position of the portion of the holder for holding a cutting insert relative to the support body.

2. The cutting tool assembly according to claim 1, wherein the holder comprises a recess for receiving the cutting insert.

3. The cutting tool assembly according to claim 1, wherein the holder is integrally formed with the support body, the support body flexing to allow movement of the portion of the holder holding the cutting insert relative to the support body.

4. The cutting tool assembly according to claim 3, wherein the holder is resilient, movement of the portion of the holder holding the cutting insert being against a resilient bias provided by the holder.

5. The cutting tool assembly according to claim 1, wherein the holder is a separate component to the support body and is moveably mounted to the support body.

6. The cutting tool assembly according to claim 5, wherein a resilient member is disposed between the holder and the support body, the resilient member providing a resilient biasing force on the holder.

7. The cutting tool assembly according to claim 5, wherein the holder is pivotally mounted to the support body.

8. The cutting tool assembly according to claim 7, wherein the holder is mounted to pivot about a pivot member extending from the support body.

9. The cutting tool assembly according to claim 5, wherein the support body comprises a first support portion and a second support portion, the holder being located between the first and second support portions.

10. The cutting tool assembly according to claim 1, wherein the support body comprises a bearing and the adjustment screw is rotatable in the bearing.

11. The cutting tool assembly according to claim 10, wherein the adjustment screw has a head and a distal end portion, the bearing being arranged at the distal end portion of the adjustment screw.

12. The cutting tool assembly according to claim 10, wherein the adjustment screw is threadably engaged with the bearing by a second thread on the shank of the adjustment screw.

13. The cutting tool assembly according to claim 12, wherein the second thread is opposite to the first thread.

14. The cutting tool assembly according to claim 1, further comprising a locking screw engaging with the adjustment screw to prevent axial movement of the adjustment screw.

15. The cutting tool assembly according to claim 13, wherein the locking screw engages with a circumferential groove formed in the adjustment screw.

16. The cutting tool assembly according to claim 1, wherein the adjustment surface extends at an angle to the longitudinal axis of the adjustment screw.

17. The cutting tool assembly according to claim 16, wherein the angle is less than 20°.

18. The cutting tool assembly according to claim 17, wherein the angle is from 3 to 12°.

19. The cutting tool assembly according to claim 1, wherein the surface of the holder contacted by the adjustment surface extends at an angle to the longitudinal axis of the adjustment screw.

20. The cutting tool assembly according to claim 19, wherein the angle is less than 20°.

21. The cutting tool assembly according to claim 20, wherein the angle is from 3 to 12°.

22. The cutting tool assembly according to claim 1, wherein both the adjustment surface and the surface of the holder contacting the adjustment surface extend at an angle to the longitudinal axis of the adjustment screw, and wherein the adjustment surface and the surface of the holder contacting the adjustment surface extend at the same angle to the longitudinal axis of the adjustment screw.
